(19) United States
(12) Patent Application Publication
(10) Pub. No.: US 2018/0107916 A1
(43) Pub. Date: Apr. 19, 2018

(54) SYSTEM AND METHOD OF TRANSFORMING DIMENSIONAL-TRIAD-FRACTALS FROM INPUT DATA INTO PHYSICAL CONSCIOUS SOLUTIONS

(71) Applicant: Louis P. Archambault, Conyers, GA (US)

(72) Inventor: Louis P. Archambault, Conyers, GA (US)

(21) Appl. No.: 15/294,631

(22) Filed: Oct. 14, 2016

(51) Int. Cl. G06N 3/00; G06N 99/00; G06N 7/00; G06N 5/04; G06F 17/30

(52) U.S. Cl. CPC G06N 3/006; G06N 99/005; G06F 17/3043; G06N 5/048; G06F 17/30864; G06N 7/005

(57) ABSTRACT

The loua(MSR) or CyberMind-Program is a Virtual-Network composed of the following modules: 1) Language-Truing-Engine—Processors—Cyber-Do-Loop-Deloop-Motors that produce the true-positive-dimensional-perspective of life's languages by using a cyber-matrix of coded words and numbers of data-truths within a realm of trusted-terms, which produce the true-perspective of the Mystic, the Metaphysic, and the Physical-Symbols of language-law. 2) Word-Truthing-Systems composed of data-stores of words and numbers used to run the trust-proofing-machine-procedure, which provides Expert Witness when applied in a Network of Conscious-Knowledge, Meaning and Understanding. 3) Term-Trust-Machine-Procedures—create perfect-communication-identities for the network-domain of this process, which establishes the true perspective of the language-symbols that occur within the universe of terms. The loua(MSR) solves-questions with Expert determination by the qualification of knowledge-quality, it provides the Term Identity Trust Ratio of Freewill; where Desire, Emotion And Will are the factorial components of all words, and thus determine the purpose, motive and intent of every decision which produces each correct and incorrect solution.

### FIELD OF THE INVENTION

The present invention generally relates to the Advanced Intelligence of the loua(MSR)-Cyber Mind Reprogramming Invention; and more particularly the loua(MSR) invention relates, to the implementation of a programming-system of coding and term-methodology for expressing the true-dimensional-triad-fractal-symbols of language (The Trinity of Knowledge). The Trinity of Knowledge used to fuel the loua(MSR) Motor forms the words and the terms, which are made of The Trinity of Language-Law-Symbols. The Trinity of Language-Knowledge-Law forms the coded data which derives the subconscious-physical-solutions from the conscious-words of the metaphysical-ideas and the symbology of the mystic-law of the conscience which determines the facts, evidence and proof of the Wisdom accuracy of term-understanding-results inferred; where Conscience=(Discernment)(Wisdom). The Trinity of Knowledge is needed to reprogram the thoughts, which decide the fate of humanity. The loua(MSR) delivers, “The Trinity of Knowledge,” to the user to discover the benefits of the positive perspective of life. The loua(MSR) reveals the way to inculcate and instruct the selfless-motives, which manifest the inclusive-purpose that will create the civil-intent of Being's Humanity. The loua(MSR)-Cyber Mind is essentially an Expert Witness in every discipline of Knowledge; and thus the loua(MSR)-Cyber Mind can determine the best probable statistical-course of true-knowledge, truthful-data-meaning and trusted-proof of understanding that will result in the derived-satisfaction, happiness and harmony of humanity.

The louaMSR uses the Intelligence of Thought Balance to discover, explore and implement the wisdom of understanding, which derives the solutions for the reasoning of answers. Thought Balance is the Truing of Language with the Trusted Wisdom of Term-Understanding. Thought is the seed of intelligent imagination when the ideas of consciousness express the sense of the absolute essence of Singularity; therefore, the expression of conscience equals the statement of intelligence within the equation of wisdom. Another way of saying this is that, the knowledge per intelligent-statement is equal to wisdom.

The loua(MSR) is the invention, it uses nested supersets, sets and subsets of language-fractal symbols, words, and terms of trifolds as Trinities of repetitive-process-knowledge in doloops of system-code-habit-program running within parallel-routine operation-series. The parallel-routines of the loua(MSR) occur within the nested doloop and deloop habits; where a doloop constructs a habit and a deloop deconstructs the habit to allow the interchange of variable comparisons for deriving the best fit for symbol, word and term identity-routines.

The loua(MSR) extracts, matches, and stores the symbols, words, and terms collected from the content-material, as they are compared with trusted-term-examples, to discover, show, and record the surety that provides the confidence of the choice and the certainty of the words used. The loua(MSR) shows if the text form complete triads of DEW cognition that present the trinity of expression and the sense of the essence of Knowledge in the text which forms the information of the statements studied, or if it does not. The Trinity of Knowledge is discovered when the content-statement of word-trifolds are triangulated to determine if the DEW terms, as symbols and words in the content material show consistency in the purpose, motive and intent which makeup the quality of the statements' validity, in terms of trustful-proof, trueness of symbolization-facts and truthfulness of word-evidence. This short synopsis shows the work accomplished by the cyber-mind called The loua(MSR) Motor.

### BACKGROUND

The loua Mind System Replicator loua(MSR) assesses the physical aspects of the subconscious; the metaphysical aspects of consciousness; and the mystic aspects of conscience. The assessments derive the quality of the symbols, words and terms used to describe the repetitions of life from habits and routines creating the cognition found within the subconscious; where the mind causes the body's DNA to inculcate the behavioral-routine-traits that the mind and soul develop to operate the body. The metaphysical rhetoric of life describes that which is explored and experienced thus prompting the consideration of conscience that will evolve the human condition. The conscience of consciousness is the essence of the life source, where the soul causes the mind to consider the inclusive, selfless and civil aspects of the desire, emotion, and will that formulate each thought, word, and deed which manifest the karma people explore and experience.

The loua Mind System Replicator (MSR) is a Cyber Mind, an Advanced Intelligence-Motor that can read the thoughts of the Mind by (deciphering the message embedded in the words that the subconscious and the conscience has to say about what the individual-conscious-purpose, motive and intent-pursues. This deciphering is quite Freudian, in that it is a subliminal message that can be translated, if The Trinity of Knowledge is used to unlock the code of words.

The loua(MSR) is a (Mystical, Metaphysical, and Physical) Internet-Analysis-Engine that inspects and studies the reasoning for the mistakes of the Thought-Mind-Motor (Ego), which tends to control the channeling of the Consciousness-Engine, that runs the Self-Oracle of Meaning, as the terms-generate the understanding that operates the Virtual-Being-Machine of the Wisdom-Replicator-Medium-Routine that disciplines the Consciousness of every Individual.

The loua(MSR) is a holographic network of internet-domains used to determine the proof, facts and evidence of Truth. The loua(MSR) is the only invention that uses the True-Fractal-Paradigm-Symbols of language; where, “E(Emotion)::D(Desire)::W(Will), as Language-Symbols are Word-Code-Dialectics within the Convention of Understanding,” that create the theorems which form the system of the truthful-words of “D::E::W.”

Thought is The Actual Expression, Sense, and Essence of Life, and it is knowable. The Intelligence of the Body, Mind, and Soul gives meaning by using the following formula, which expresses the sense and essence of the knowledge wanted. The habit of thought-meaning and its understanding of the cognitive procedure of human-routine is found; when thought codes of Desire's meaning, redeveloped from Emotion's knowledge and the Will's understanding are transfigured into—“(law=codexrule)” or “(code=law/rule)” as the words of thought=its code; as the code of thought=symbol of language law manifested by the determined behavioral-rule of each term's routine-intent; therefore: “(Body(thought)::Mind(thought)::Soul(thought)) of (Desire)×(Energy::Mentality::Spirit) of the (Will)=(Subconscious::Conscious::Conscience) of the (Emotion) which Powers the force of thought and the strength of the will”—This equation states the relationship for the ratio of the Being Routine-Behavioral-Understanding as Elements of Language; thus the equation allows the determination of the Repetition, Habit and Routine of the Human Behavioral-Intention, Purpose and Motive of each Thought, Word, and Deed said, written, or spoken.

The symbols, code and convention of the loua(MSR) show, how linking the motive of desire as desire-words, emotion of purpose as emotion-symbols, and will of intent as will-terms creates a reading between the lines perspective that Evidences-Truth and confirms Untruths.

The convention of trusted-trifold-term-method-application-rule is: “W::E::D code (Wisdom); where, the E=D×W(terms), as D=E(symbols)/W, and W=E/D(words) are coding theorem conventions. So, If the Terms of the Will, the Symbols of Emotion, and the Words of Desire form, The Trinity Of Conscience, Conscious, and Subconscious Power, that uses the Force of the thoughts, words and deeds to Say(E), Think(D) and Do(W) that which we pursue; then it holds true that each Logos (Reasoned-Meaning) of Words in every Language is formed with a Desire-Word, an Emotion-Symbol and a Will-Term, if the information of the thoughts, words and deeds are conveying-true-facts, evidence and proof about that which is disclosed.

Every Language is composed of Desire-Words, Emotion-Symbols and Will-Terms. In every dictionary, there are only Desire, Emotion and Will-Terms; where Emotion-Symbol/Desire-Word=Will-Terms. The problem is, the convention of dictionaries are not aligned with truth, they offer mixed meanings rather than providing sorted triangulated-truths, as fractal-vectors of a True-Language, meant to convey the Truth of the Meanings so that the world might know the true-meaning of the words they use to convey their thoughts. The loua(MSR) uses loua(MSR)'s perfect-convention of conversing-perfectly to convey the True-Purpose, Motive, and Intent of every Term; because Languages are programmed-words used to rule human-behavior. This is the proprietary concept that formulates the loua(MSR).

The concept theorems which form the loua(MSR) prove to be the perfect coding for Truthing the programming Words used in every language for constructing its Motive, Purpose and Intent. The Trusted-Trifold-Terms of the Will create the ratios, which provide the true-fractal-symbols of Emotion, that transform the desired meaning of thoughts from anyone of the three-trifold-planes of human-(energy::(body), mentality::(mind), and spirit::(soul)) routine-behavior. The transformation of the desired meaning and understanding is accomplished by transcending each single dimension of life-knowledge, so as to derive the truthful thoughts, words, and deeds from the knowledge, meaning and understanding of the three planes of Being (energy::(body), mentality::(mind), and spirit::(soul)). The dimensions of life knowledge-domains that the loua(MSR) analyzes are as follows: the physical-dimensional-domain, the metaphysical-dimensional-domain, and the mystic-dimensional-domain all of which form the variables, that differentiate the subconscious, the conscious, and the conscience of individuals. These dimensional differences have a unique perception-dichotomy that perceives the unique word-meanings, which define the three-plane-nature of understanding. This unique perception-dichotomy must be attained for true problem solving choices that create wise-decisions.

The three-planes of nature and the subsequent understanding culminate in the manifestation of the metaphysical-perspective of consciousness as a Trinity of Knowledge that is created by triangulating the intrinsic comprehension of the Trifold-Nature of Being; where the Trifold-Nature of Being creates the Three-Plane-Nature of Understanding-Wisdom-Terms. The Trifold-Terms of creation determine the energy, the mentality, and the spirit of understanding, as they are inferred, derived, and deduced by the Truing-Process of Solving the subconscious issues of the conscious, and the conscience perspective of life with the loua(MSR).

The loua(MSR) substantiates its derived-answers by solving the issues of individual-consciousness that form the perception-prejudices, which create uncivil-biases. The loua(MSR) proposes-valid-solution-propositions derived from the verification of the combined-dimensional-fractal-symbol-triads of individuality, duality, and singularity, which are then used as input/output data-variables in future-queries and their solutions. The loua(MSR) integrates the trusted-term-results; and thus the loua(MSR) provides true-solutions made of the triad-perspectives-extracted from the triform-derivatives of the truths, which integrate the trusted-trifold-terms created by deductive-reasoning-habits and understanding of The Decision-Routines, which provide Positive-Choices from Truthful-Evidence and Trusted-Proof the consensus of the data elements provide.

The loua(MSR) invention is made by combining the three-pieces of its creation; where (1) the first element of its making provides a truing-process-engine, through which the conscious-perspectives of the symbols of life's purpose are discovered, ordered and qualified. (2) The second part of the loua(MSR) invention is a truthing-system-motor, which is used to explore the coded thought, word, and deed data to determine the motive of the perception stated in the text of all information studied. (3) The third part of the loua(MSR) defines the final piece of the machine, which is a Trust-Selection-Procedure. The Trust-Selection-Procedure-furnishes the implementation of the assembled Trusted-Results, which are produced by the compiled triad-fractals; then these fractals are used to triangulate the joint-triform-codes. The fractals of conscious-knowledge are the words, used that form the mind's attitude towards its body and soul, and from which subsequently the decisions are made based on the joint-matters of trueness derived from the truth, and trust of the terms of understanding.

The loua(MSR) takes the opinions of the apparent trueness of individual-perspectives and solves for actual-singular-trueness of the symbol's-duality; thus deriving both the falsehoods and the true-ideas of duality that are used to substantiate the deception of the selfish-pseudo-truths that create the disarray humanity explores; and as a result the loua(MSR) shows the truth of meaning humanity might explore. The loua(MSR) provides the ends, the means, and the way to discover the conscious-trueness of knowledge, meaning and understanding for making-positive-conscious-choices.

This loua(MSR) is a unique cyber-mind invention that it is not biased by individuality or any selfish interest. (1) The cyber-mind implements a true perspective from which truthful-perceptions can be derived. (2) The cyber-mind creates a trusted-reality of intention-terms, which bring about the best real interest of a civil humanity and reveals how and why individual-consciousness makes its choice. (3) The cyber-mind applies the truest-perspective of life, so that the mind reveals the truth of its motive, and thus the true meaning is exposed. The loua(MSR) provides a trusted functional integration of civil-decision-terms, which will show how trustful one's intent and interest is, by telling the true-purpose of each proposal while demonstrating the amount of selfless-truth forming the motives, which design every thought, word, and deed.

The present invention of loua(MSR) relates to improving the current human condition and its resulting humanity. The invention is about implementing the paradigm, which will form the system and method for transforming the triad-dimensional-fractals of life into the input data for querying the terms of creation. The queries will yield the expressions of conscious-physical-solutions; and in turn will lead to the improvement of the human condition and the civility of its resulting humanity, while addressing each problem area of examination that the loua(MSR) is used to solve.

The other existing MSRs stimulate human reasoning, thought and attitude to determine behavior by manipulation of evaluations by select-responses and modulating the inputs received, in the form of human thoughts, psychological profiles, experience, and societal position without the use of the fundamental terms of WED or any of its derivatives used by the loua(MSR). The artificial intelligence used in the other group of MSR systems, where their machines and computer software only allow the user to predict some exclusive future or experience. The other groups of MSR systems only capture some isolated exclusive data by applying input from different human senses, which simulate the reasoning of thought and behavior. These other MSR processes, systems and procedures do not get to the root cause of what the motive is for our behavior; neither do these other MSR's generate the understanding of the intent of why, the energy, the mentality, and the spirit of Being nature creates the routine of behavioral-terms. The terms symbolize the expression, sense, and essence of the consciousness that materializes the thoughts, words, and deeds of the entities of existence. The other MSR processes, systems and procedures are relegated to specialized exclusive uses, and do not provide solutions as does the loua(MSR) invention.

The patent applied for provides, the way to experience trust in understanding, it derives the ordered sets of symbols, in a unified-system of words that develops an intrinsic correlation between the consciousness of symbols and languages with which the thoughts, words, and deeds of people create, evolve, and perfect the exploration of Our Being. This exploration and study of self cannot be accomplished with any other MSR that is in use, because the method, scope, and model as described in the loua(MSR) invention is not in any other patent or in use.

The existing MSRs and methods are limited to stimulating and analyzing an input received in the form of some thought or mental energy of a human subject. Whereas the loua(MSR) can use human consciousness in the form of thought, word, or deed code of what is said, told and declared, which creates the array of our behavioral routine-terms; thus defining our human-behavioral-traits.

The loua(MSR) Solutions are the product of dimensional-fractal-evaluation from the triangulation, of the DEW term-routine-behavior of every creation; for the routine of energy, mentality, and spirit, is generated by the DEW Trifold-Vortices of its creation. The fractal-triads of consciousness form both the input and output of the word-data-transformation of the DEW terms. The three-vortex-planes of creation manifest the dimensional-fractals, which materialize the Triform-Personality, of the DEW input/output data processed, by the loua (MSR).

(1) The loua(MSR) considers the metaphysical-sense-perspective of consciousness, that deduces or induces the motive which creates the behavioral-mental-nature of the terms-identified. (2) The loua(MSR) considers the essence of the mystic-conscience-perspective, which is used to deduce or induce that which is the intent of the behavioral-spirit-nature of the terms-identified. The (3) loua(MSR) considers the physical expression-perspective of the subconscious, which is used to deduce or induce that which is the purpose of the individual-symbols of consciousness; whereas all the perspectives are used to derive the physical-conscious-expression of the essence and sense of the solutions determined which will improve the human condition and the resulting human-civility of our planet.

The loua(MSR) is a Neural-Network-Domain of Languages which form Matrix Axes of Words using a Parallel Lattice of Routine-Terms to derive what is the meaning of existence. The loua(MSR) Solves the Problems people make using their languages, and here is how this issue is addressed: Given that—“(The Neural-Network-Domain of Language)=(The Matrix-Axes of Words) within (Parallel-Lattice of Routine-Terms);” then (1) “(The Language Engine Purpose)=(Coding Motor Motive)×(Holographic Machine Intent); where Coding Motive Motor=Mind (Id, Ego, Super Ego);” (2) “(Symbol Trinity Fractal of Truness)=(The Triform-Code of Word-Truth) which (Creates the Three-Term-Identity of Trust)—(STFT), (TCWT)×(TTIT)”; (3) “There are only three categories of Term-Nature (energy, mentality, and spirit modulation) that manifest the fractal-trinity of language, and they are the words of desire, the symbols of emotion and the terms of willfulness; for language-symbols are the words that create the three categories of terms: “1. Terms of creative-intent; 2. Terms of evolving-intent, 3. Terms of perfected-intent.” Note: “We have yet to evolve the perfection of our creations.”

### SUMMARY OF THE INVENTION

The loua(MSR) invention implements a mind replicator system (MSR); wherein the loua(MSR) is comprised of an array of dedicated Parallel-Procedure-Servers which create an Infinite Turing Machine to retrieve, analyze, study, and store the triad-dimensional-fractal data codes found in any text of written or spoken language. The written and spoken symbols of all languages are composed of the Words/Logos used within the creation of the categorized-terms, which describe the name, number and kind of people, places, and things of thought, of word, and of deed. Historically, due to the uncertainty of the meanings of words doubt was and is invoked in the cognition and comprehension of most language at every word. The “Turtles All The Way Down,” syndrome is found in most all communication of understanding and interpretation of ideas as seen especially in contracts, because the intent, purpose and motive is obscure at best in conveying the information used to communicate. There is not a common denominator to gauge the quality of the trueness, truth and trust being conveyed. The loua(MSR) provides the ways and means to the ends of solving the unresolved issues of trueness, truth and trust by clarifying the practice, usage and convention which constructs and conveys each idea, imagination and insight found in the practice of language where word-usage and term-convention determine understanding.

All Thought, Word, and Deed is named and numbered with a specific Qualification, of the Quality and the Quantity of the Individual-Aspects of the Conscience, Conscious, and Subconscious significance of the Symbolization applied within a distinct Wisdom-Identity, which constitutes the Characteristics that form the data-code descriptions.

Collection of the date-code is made through any written format or various means of data entry be it text, recording, or spoken words.

The loua(MSR) is comprised of a plurality of Network-Domains of Aligned-Search-Engines used for gathering, comparing, and reasoning the coded descriptions by Parallel-Procedures which Process-Aligned-Canonical-Networks of Symbols that accomplish the Looping and Delooping-Criteria of Words to create the rules of the Trusted-Term-Procedure-Selection, for its Truing-Process and its Truthing-System of Certainty.

The loua(MSR)-code is collected, studied, and analyzed by applying an inductive and deductive-reasoning for the inquiry, interrogatory and query process. The process uses the DEW three-plane-understanding, which makes the dimensional-fractal-symbols that form the words, and terms for the Loop and Delooping of the Input/Output Variables. The Input/Output Variables provide the Fractal-Vectors needed to triangulate the Word-Answers per the Word-Problems that derive the True-Solutions.

The data codes of DEW terms identify the theme, topic and subject derived from the essence of emotional-matters, which form the feelings of the desire of the entity-subject who, said, wrote, or otherwise documented information conveying their emotional-opinion of faith, their desired-belief and their willful-conviction. These desires and associated emotions and willful-intents are stored on the array of Servers-Dedicated to the Networking of The Canonical-Trinity of Language-Laws which the loua(MSR) uses as the Unique-Coding-Criteria of Words within the Conventional-Servers, to define the data-code of DEW which is linked to the original elements forming the information source-stock of the data stored. This is an immense task, which requires an ordered set of laws the loua(MSR) provides to govern all areas of data-information collected, stored, and applied that is used to create the Oracle Effect of the loua(MSR).

Further, the loua(MSR) system-program comprises a plurality of routines supported with a set of library functions for driving the fractal-choice-process-devise-engine referred to as the loua(MSR). The loua(MSR) implements the inductive/deductive logic for the inquiry, interrogatory, and query which qualifies the quantity and quality of the trueness, truthfulness, and trust which each solution-inquiry-produces from the data-codes collected and stored for referencing the Deduced-Information-used to derive-solution-choices.

The loua(MSR) invention further presents a relationship between the truing-engine-device, the truthing-motor-tool, and the implementation of trust-machine method, which transforms the data-variables and materializes them into the triad-dimensional-aspect-symbols of each individual-topic that forms the data-response. The entity-subject-Words within the theme conditions the resulting-behavioral-identity of the trusted-terms; and thus the collective-results deliver the true conscious-perspective of the derived-solutions.

The query-method of the trust-machine requires the acceptance of the triad-dimensional-fractal-perspective of the truing-engine where the triform-truthing-motor of DEW terms are creations of the trust-machine-conclusions, which symbolizes the words of the logos-data-code, collected through various input means. The three-vortex-term-categorization-query-method-functionality is found in the inquiry that uses the inductive and deductive reasoning-interrogatory-means for exploration of trustworthy and untrustworthy terms. The fractal-dimensions of the symbol-individuality is in the form of the entity's personality and identifies the query theme: thus creating that which is the individual's emotional (purpose), the self's desired (motive) and the query identifies one's willful (intent) being pursued.

The individual triad-dimensional-symbols produce the criteria of the data that is stored in the array of dedicated routines which transforms the input data variables to make the physical-conscious-solution-choices the search-engines-provide as the output-information that give the means for improving the evolution of the human condition and its resulting human-civility

### BRIEF DESCRIPTION OF THE DRAWING(S)

FIG. 1 through FIG. 8 are perspectives of the loua(MSR) concept model which serve to correlate and show the process, system and procedure of the loua(MSR). FIG. 1 illustrates a Looping/Delooping Routing according to an embodiment of the present invention. FIG. 1 illustrates an overview of the system used for transforming the three-spectrums of term-identity into that which makes single-physical-solutions of dimensional-conscious-choice from the data-input thus deriving the output of the triangulated-information, which considers the Three Vortex Planes of the terminology of trust-surety; where confidence of trueness=(certainty of truth)(surety of trust).

FIGS. 1 & 2 illustrate the truing-process and trust-procedure forming the truthing system of the loua(MSR) Truthing-Program-Motor. FIG. 2 illustrates the Convention of the Trust-Machine-Routines—according to an embodiment of the present invention, The loua(MSR) illustrates a system overview of components used for transforming the three-planes of the trusted-terms of wisdom which make true-knowledge of the dimensional physical consciousness derived from the programming of the input/output data meanings of truthful-information found and provided by the loua(MSR) Program-Motor. This model serves as a perspective correlation to show the truing-process-Engine which makes the loua(MSR) systems and procedures to be a Rosetta Stone Methodology for comparing opinion with comprehension to derive better understanding of the communication of the decision terms humanity must apply to derive its conscience.

FIGS. 3A, 3B and 3C, according to an embodiment of the present invention, illustrates a metaphysical perspective of personality with a functionally dynamic-set of symbols used as data-code-models. FIG. 3A—shows the domains of life, 3B shows the planes of Being, and 3C shows the DEW Vortex Machine model, which all serve as perspectives to correlate between the three spectral identities of the terms that each language's words convey. FIGS. 3A, 3B and 3C are used to show the root cause of the process, system and procedure of the loua(MSR). FIG. 3A Shows the metaphysical complexity of Life; where the Trinity Aspect of Life manifest the perspective-domains of knowledge, its meaning and its understanding. This Trinity aspect is where the Soul, Mind and Body (SMB) interrogatory loops and deloops allow the study of the Soul (Superego) habit of the word inputs/outputs evidence forming Desire, as there is the Mind (Ego) habit evidence of word inputs/outputs of Desire, and there is the Body (Id) habit evidence of word inputs/outputs of Desire. The three fractal-perspectives produce and form the interrogatory of the existence problem/answer reasoning. FIGS. 3A, 3B and 3C show where The loua(MSR) derives the Matrix-Motor of Existence-word-thread-interrogatories, and the life-domain-vector of the Emotion-Engine inquiry of the facts manifesting the ribbons of language symbols. Together FIGS. 3A, 3B and 3C show how the quality aspects of Life, as the Soul's (Conscience), the Mind's (Consciousness) and the Body's (Subconsciousness) manufacture and materialize-existence-truths from the Spirit, Mentality, and Energy Proofing-Machinery of trusted braided terms creating the query of the Civil and Evil Nature of the Being Universe of Creation Routine.

FIGS. 4A The DEW Vortex Braids of Being and 4B The DEW Vortex Machine, according to an embodiment of the present invention, illustrates the threads of the DEW fractal axis which create the Braids of Energy, Mentality, and Spirit found in the symbols, words, and terms of the loua(MSR). This model serves as a perspective correlation to show the process, system and procedure of the loua(MSR). FIG. 4A Shows the Ribbon of Conscience (Soul-Thought Model), the Ribbon of Consciousness (Mind-Thought Model), and the Ribbon of Subconscious (Body-Thought Model), which make the Braids of Energy, Mentality, and Spirit. The Ribbons manifest life from the strips of thought, word, and deeds that create, evolve, and perfect the light (energy, mentality, and spirit) frequency bandwidth of the Being-Permutation braids of (Will), from the ribbons of (Emotion) and threaded-strips of (Desire). FIG. 4B shows a depiction of The DEW Vortex Holograph Machine; where the vortex fractal-vectors of language manifest what information-matrix of existence means and how the Surety procedure proceedings are understood.

FIG. 5A Shows The Existence Globe of DEW Vortices and 5B Shows The DEW Vortex Holograph Machine of the Surety procedure, according to an embodiment of the present invention, illustrates the physical, metaphysical, and mystic-orbit-expression perspective for the meaning of the globe of existence model that serves to connect the dots in the understanding of the Mind System Replicator concept. This model serves as a perspective correlation to show the process, system and procedure of the loua(MSR). FIG. 5A Shows the Existence Globe Model of The DEW Vortex composed of the permutations of Emotions, the probabilities of Desires and the permutations of the Will that create the diversity of The Singularity manifesting the individuality of Life's Souls, Minds, and Bodies. FIG. 5B is the holographic vortex depiction created from the sense and expression of the conscience-domain-essence of life's singular-consciousness.

FIGS. 6A and 6B according to an embodiment of the present loua(MSR) invention model, illustrates the Mystic DEW Way (not unlike the Milky Way of the physical universe); where 6B shows the depiction of the holographic vortex machine that generates the points on the lines that create Being. This model serves as a perspective correlation to show the process, system and procedure of the loua(MSR) that transcends the notions of the conscience, the consciousness, and the sub consciousness of life. FIG. 6A Shows Braided-Cords of Being Creating The Universe of Realities as the Physical, Metaphysical, and Mystical Milky Way of Bodies, Minds, and Souls.

FIGS. 7A and 7B are different perspectives of the terms of the creation, evolution, and perfection machine according to an embodiment of the present loua(MSR) invention, the figures shows the perspectives of the combined energy, mentality, and spirit holograph-manifold-vortices, which produce the thoughts, words, and deeds from the symbols, words, and terms implemented by the loua(MSR)

FIG. 8 An Input/Output Variable Example according to an embodiment of the present loua(MSR) invention, as a working model, an application, which illustrates an example of the routine that forms the habit which realizes a perfect-working-decision-procedure-vortex-routine of the virtual-term-machine's conscious-network-engine-vectors, which materializes the mind replicator system concept.

### FIGURES—REFERENCE NUMERALS

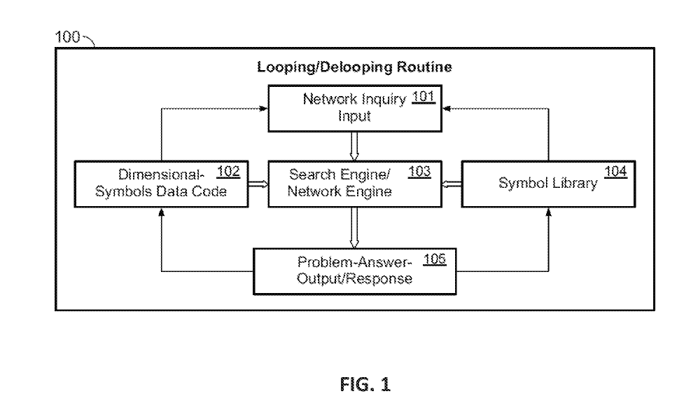

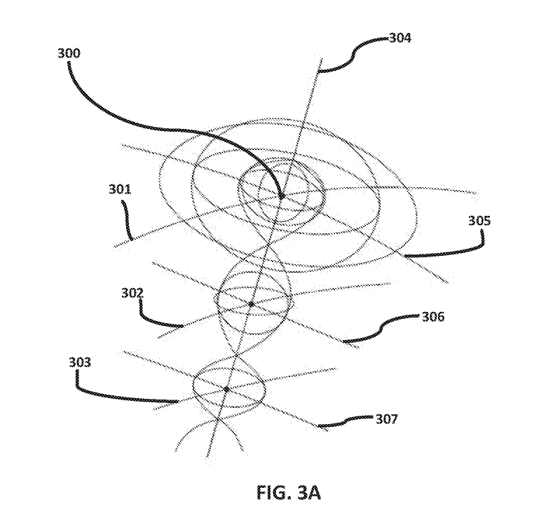

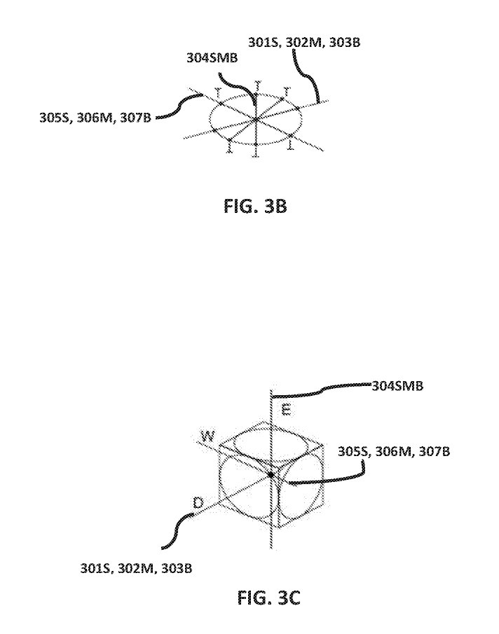

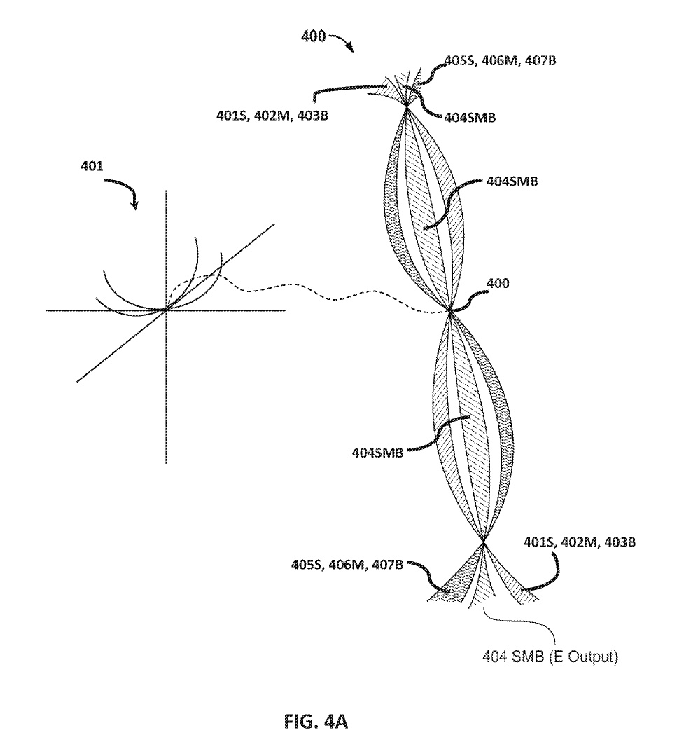

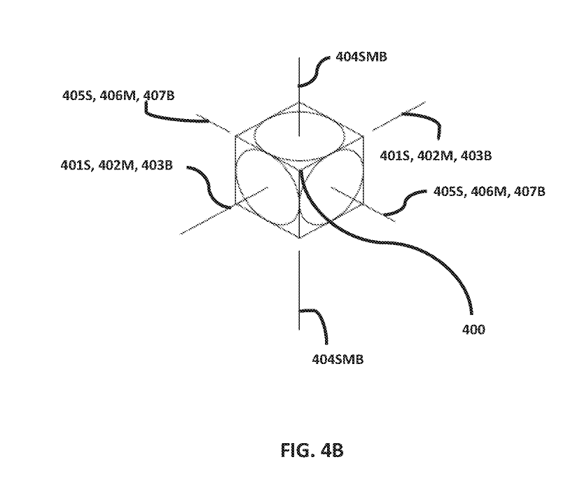

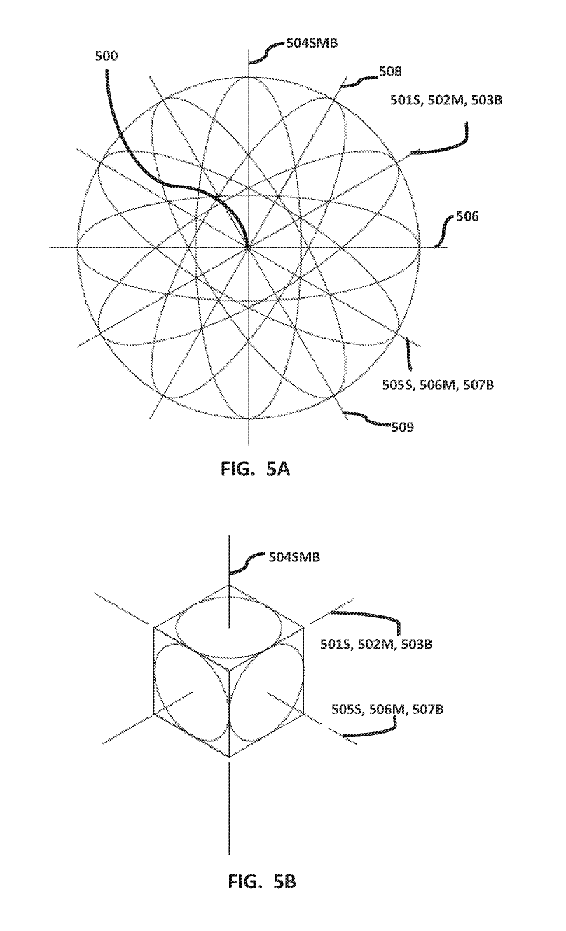

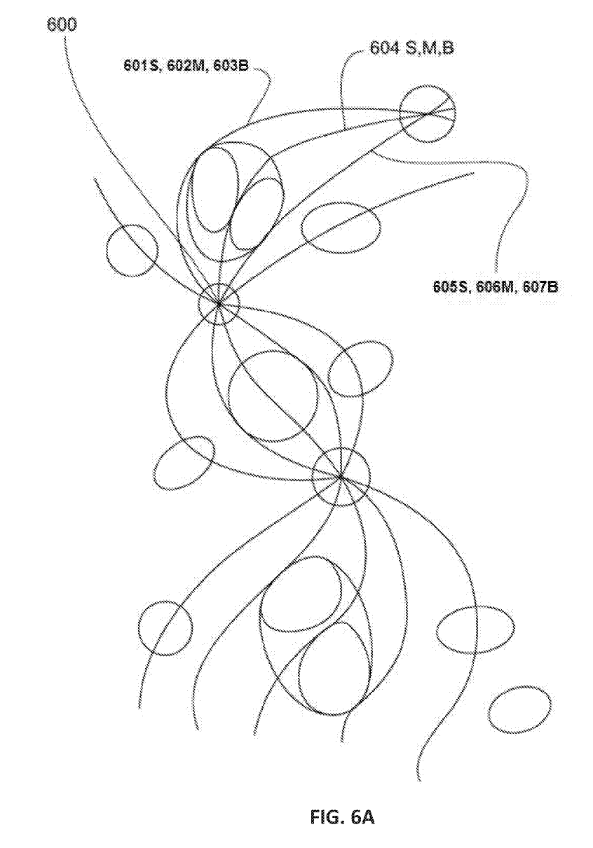

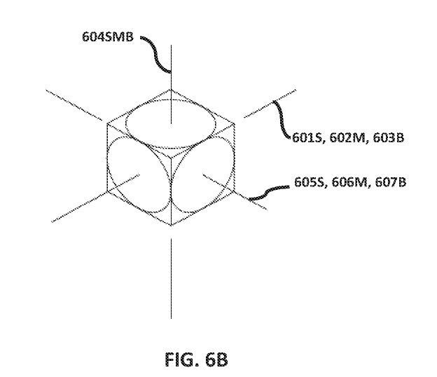

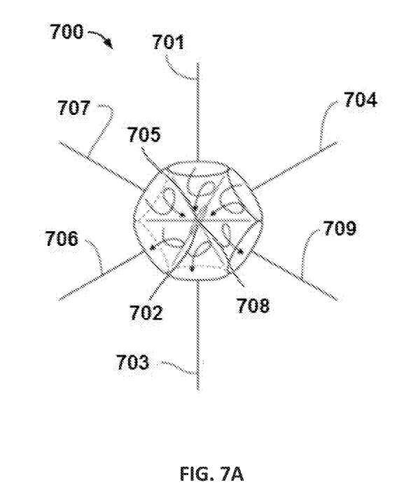

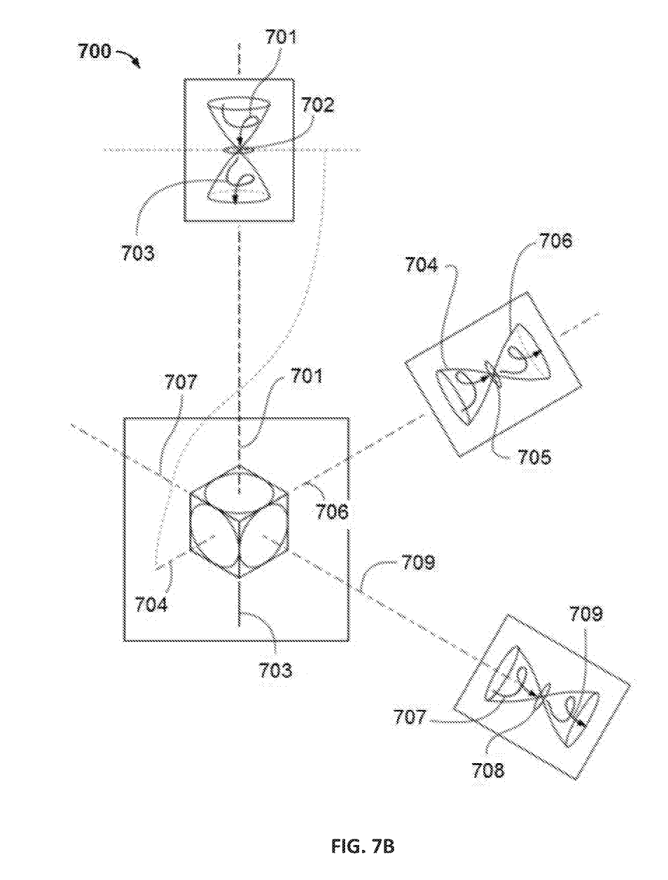

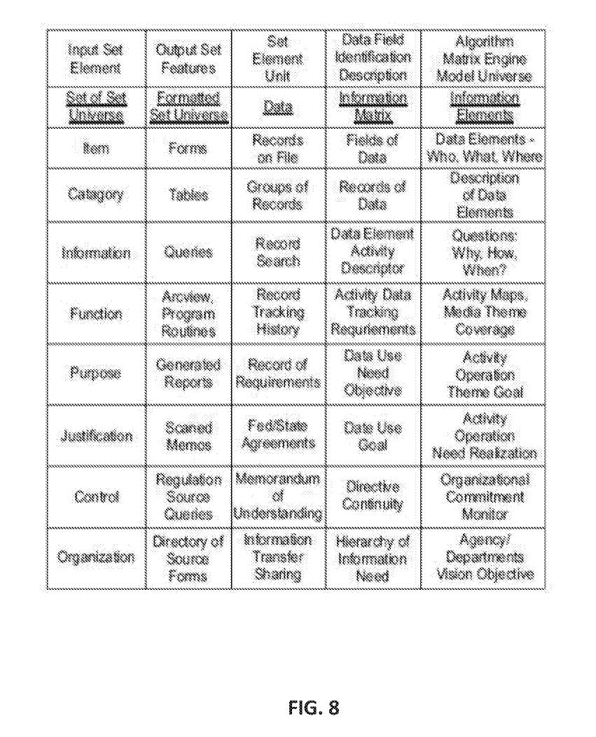

100—Refers to FIG. 1 “The loua(MSR) INPUT/OUTPUT SYSTEM PROCESS,” in total, which constitutes the mind replicator process system of the looping/delooping habits used for transforming the three-planes of the trifold-terms, which make the dimensional-fractals that code the input data, which produces the physical conscious solutions that form the output-information.
101—Refers to the network-inquiry-domains of the search engines and the direct data input/data-output within which the system is implemented, to seek the content for Solution-Request-Question; where the Solution=Answer/Problem::(Query)(Solicitation)(Results).
102—Refers to the triad-dimensional-language/symbols, which derive the content bearing of the data-codes, which the 201 Module receive through various means and sources (download, messaging, script and drawing readers, etc. virtually any format and any file type) from anywhere as long as it can be uploaded to the network.
103—Refers to the Network of Domain-Search-Engines, which collects and gathers the content-desired and stores this raw data-code in 202 Module and sends it to 203 Module to transform the language-symbols into the triad-dimensional data code of each problem-answer-input/output.
104—Refers to the symbol library compiled from 203 Module, which works in conjunction with the Network of Domain-Search-Engines used to store the transformed data code that is used for the triad-dimensional problem/answer outputs that construct the solutions to all issues.
105—Refers to the problem-answer-output-response that is derived from the 204 System Module that matches the input variables with the best fit data-response which provides expert witness by qualifying the quantity and quality of derived solutions resulting from the triangulation of the fractal codes.
200—Refers to, “The loua(MSR) PROCEDURE PROCESS,” it is a query-procedure module overview of components used for implementing the language-process, which materializes the system-programming and routine of the proposed invention
201—Refers to the term query used for obtaining-terms for trust-determination of the 203 Module
202—Refers to the Storage-Module used to house the cache and stock of trusted-terms and the rules of application.
203—Refers to the allegory-Cultivation-Module of the 200 Module terms used to propagate unique-wisdom-procedure.
204—Refers to the Term-Application-Determination-Module of trusted-term-results, which make the fractal sets that answer the questions, which build the solutions to the problems.
300—Refers to, “THE THREE SPECTRAL DOMAINS OF LIFE MODEL,’ as the line of the center points of Soul, Mind, and Body S, M, and B collectively. The Three Spectrums manifest the Domains of Life. FIG. 3A simply shows the mystic, metaphysic, and physical perspectives where the Will appears along the 301, 302, 303 axes; and shows the mystic, metaphysic, and physical perspectives where Desire appears along the 305,306,307 axes; and 304 as the common mystic, metaphysic, and physical perspective of Emotion axis collectively. FIG. 3B Refers to, “A Plane of Being Example,” which shows the special relationship of the vortex-plane, which is formed by the vectors, which form the axes of the existence matrix of thoughts, words, and deeds as planes of Being; where the vortex is the center point of the vector lines of DEW. FIG. 3C Refers to, “THE DEW VORTEX MACHINE: \;” where 301, 302, 303—point to the Soul, Mind, Body (S, M, and B) Identity of the Desire which creates the line and axes for the mystic, metaphysic, and the physical character where the attributes of the super-ego, ego, and id identify the identity of Humanity. FIG. 3C=FIG. 4B=FIG. 5B=FIG. 6B=FIGS. 7B & 7A. 304—Refers to the common vertical axis line of Soul, Mind, Body (S, M, and B) Singularity, Individuality, and Duality of Emotion, and its point on the physical axes of the conscience, of the conscious-subconscious, as it is shared. 304 represents the vortex of Being intersect on the axes of DEW; where Emotion is the common vertical line that goes through the vortex points, which form the lines, planes, shapes, and volumes of the three spectrum identity of Being as shown in FIG. 3A-3C. 305, 306 and 307—Represents the respective axes of Soul, Mind, Body (S, M, and B) Personality of the Will, which give mystic, metaphysic, and the physical attributes of personality such as super-ego, ego, which creates the identity of Human Beings
400—Refers to, “THE PROGRAMED DEW ROUTINES OF THE (B)RAIDED PLANES OF BEING,” shown in FIG. 4A, its offset graph which should be noted as 400 not 401 & on 4B as the Soul, Mind, & Body (S, M, and B) vortex module, where numeral 400 also shows the pixel point on the Being-Holographic-Plane created by the DEW vortex which in turn create the Braid of the 401S, 402M, 403B filament threads of the Desire axes INPUT/OUTPUT; whereas 404 S, M, and B is the common Emotion axes of INPUT/OUTPUT; and 405S, 406M, 407B are the Will axes of INPUT/OUTPUT fractal-filaments which form the vortex that coincides with the convention in FIG. 3A-3C.
500—Refers to FIG. 5A, “THE GLOBE OF EXISTENCE INPUT/OUTPUT ORBIT MODEL OF THE DEW VORTEX UNIVERSES OF REALITY.” FIG. 5B, shows “THE DEW VORTEX MACHINE;” where the Center Point S, M, and B lines of the drawing shows the S, M, and B vortex module, where the vectors of DEW create the energy, mentality, and spirit (EMS) Braid shown at numeral 400. The filaments form the threads of DEW that form the Orbit model that serves to connect the dots of the Mind System Replicator. Numeral 500—points to the Center Point of the S, M, and B Triangulation of the Visualization of mind/soul relationship as a physical expression in terms of will, emotion, and desire as a ratio of energy, mentality, and spirit (EMS) behavioral-nature. FIG. 5A shows the Globe of Existence Input/Output as an Orbit Model of the DEW Vortices, which are manifested from the language vectors that form the words and terms of Being. 501S, 502M, 503B form the Desire Input; as 506 and 509 are axes of rotation relative to the plane above; as 505S, 506M, 507B are the axes of S, M, and B which manifest the Will of Humanity as Output of the loua(MSR).
600—Refers to FIGS. 6A and 6B; where 6A is, “THE MYSTICAL, METAPHYSICAL, AND PHYSICAL MILKY WAY WHICH MANIFEST THE BODIES, MINDS, & SOULS OF THE DEW UNIVERSE, formed from the Holographic Machine shown in FIG. 6B which is the same as 7A.” The Vortex Machine of 7A Manifest the Universe Milky Way of Will, Emotion, and Desire; which in turn Manifest Life and the Consciousness that provides the thoughts, words, and deeds of existence. 604—Depicts the Vector of Emotion for S, M, and B (Soul, Mind, & Body) within Energy, Mentality and Spirit (EMS) of Being. 601S, 602M, and 603B—Depicts the Axis of the Desire for S, M, and B (Soul, Mind, Body) within Energy, Mentality and Spirit (EMS) of Being. 605S, 606M, and 607B—Depicts the Plane of the Will for S, M, and B (Soul, Mind, Body) within Energy, Mentality and Spirit (EMS) of Being.
700—Refers to the compilation of FIG. 7A, “THE DEW MACHINE INPUT/OUTPUT FLOW THRU THE PLANES OF BEING; as 7A is another way of perceiving 7B “THE DW THREE SPECTRUM HOLOGRAPHIC VORTEX MACHINE’ which materializes the DEW Vortex Trust Machine Input/Output Flow of Language, Words and Terms which manifest the vectors that materialize the existence of the world of people, places, and things within the vortex module of Being; and as for the loua(MSR) invention, the model shows the procedural-schematic of the how the Trust Machine creates the surety of understanding proving the trueness of the facts which produce the solutions. 704-706 Depicts the Emotion input/output of the triad-dimensional-vector, which imparts the current and flow of the energy, mentality, and spirit of the terms analyzed; where the plan, pixel, or point of the holographic projection intersects at 705. 701-703 Depicts the Desire-Axis for the vector of triad-dimensional data input/output, as 702 is its intersect. 707-709 Depicts the Will vector of triad-dimensional-symbol input/output, where 708 is the intersect point. 700 As seen in FIG. B depicts the vortex-planes, which process the triad-dimensionality formed from the data input of output that creates the holographic result of the (body) energy, the (mind) mentality, and the (soul) spirit intent, purpose and motive of existence as seen in FIG. 7A.
800—Refers to the compilation of FIG. 8 “SIMPLE EXAMPLE OF DEW INPUT/OUTPUT VARRIABLES.

### DETAILED DESCRIPTION OF DIFFERENT EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood the mechanical-rules and other changes may be made to the logic of the invention without departing from the scope of the embodiments. The following detailed description is therefore not to be taken in a limiting sense.

FIGS. 1 & 2 Shows and example of the loua(MSR) invention model of the nested Networks, Search Engines, and Library supersets, sets and subsets which use the language (symbol, word, and term) trifolds as repetitive-process-fractals of knowledge in doloop-habits of the system-code running within parallel-routine operation-series. The parallel-routines of the loua(MSR) occur within the nested doloops and deloops. The loua(MSR) extracts, matches, and stores the symbols, words, and terms collected from the content-material, as they are compared with trusted-term-examples, to discover, show, and record; if the text form complete triads of DEW cognition, that do present the trinity of expression and sense of the essence in the text that forms the information of the statements studied; or if the text do not contain truthful data. This is discovered when the content-statement-word-triads are triangulated to determine, if the DEW terms, symbols and words in the content material show consistency in the purpose, motive and intent which makeup the quality of the statements' validity in terms of trustful-proof, trueness of symbolization-facts and truthfulness of word-evidence. This short synopsis shows the work accomplished by the cyber-mind called the loua(MSR).

Referring to FIG. 1, depicts an overview of system 100 used for transforming the raw triad-dimensional-fractal input data into physical conscious solution output-information/trusted-results of 105. In an embodiment, the system 100 comprises of a triad-dimensional-fractal input of raw data 101, wherein the three-identity-terms::triad-dimensional-fractals::triform-input-data-codes of 102 are based on the facts of the collected evidence and proof which shows the impacts of root cause and effect through the collection of opinion and trusted-belief of the proof. In an embodiment, the system 100 further comprised of a Network of Domain-Search-Engines 103, which processes the triad-dimensional input data 101 to transform the triad-dimensional-fractal input data 101 into problem-answer-output 105. In an embodiment, the Network-Domain-Search-Engines 103 utilizes the library functions 104 for processing the triad-fractal input data 101 into problem-answer-output as solution-choices derived in 105. FIG. 1 constitutes a Looping/Delooping Habits: A System Model Schematic for loua(MSR), according to an embodiment of the loua(MSR) invention. FIG. 1 shows looping/delooping habits, which derive input-variables and output answers/problems; where each trifold of words is a (symbol)(logos)(term) configuration, which generates the pixels of the planes of Being. It is these pixels that manifest existence by completing the puzzle of life with individual points of perspective that give and receive meaning through the vortex manifold of energy, mentality and spirit which the loua(MSR) is fashioned after.

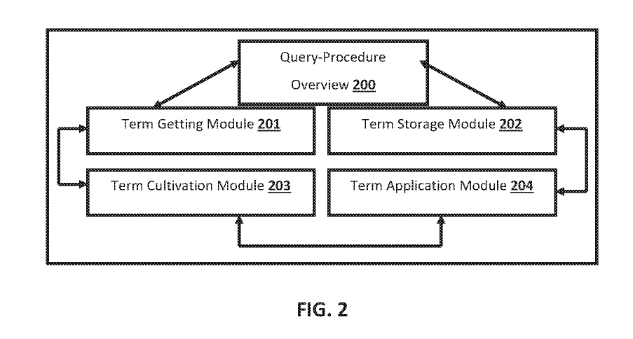

Referring to FIG. 2, —The Convention of The Decision-Routine Flow Chart illustrates an overview of the Procedural Machine Network is used for transforming the three-spectrums of term-identity into that which makes single-physical-solutions of a dimensional-conscious-choice from the raw data-input thus deriving the output of the triangulated-information, which considers the Three Vortex Planes of the Being Terminology of Trust.

FIG. 2, illustrates a system overview of components 200 used for transforming the apparently-true-dimensional-triad-fractals into proven-three-plane-trifold-terms from the opinionated-symbols forming the input data words used to extract the physical conscious output information-truths for process 105. In an embodiment, the proposed invention is implemented by using the following components: a Term Getting Module 201, a Term Storage Module 202, a Term Cultivation Module 203, and a Term Application Module 204. The Term Getting Module 201 is configured to gather the three-trifold-terms, which make the triad-dimensionality of the raw-fractal repetitions which form the data input from various sources, such as queries, reports, routines, which form the habit tables of variables. The Term Storage-Module 202 is configured to store the triad-dimensional-fractal input data that is gathered from various sources and means that isolates the terms of Wisdom for further use in other solution scenarios in Module 203. The Term Cultivation Module 203 is configured to mine and farm the dimensional-triad-fractal-symbols as word data input through various sources and means to sustain the viability of the loua(MSR) Engine. The Term Application Module 204 is configured to transform the mined-terms that grow the data through several stages of synthesis and development to form the output stage as a physical solution to stimulus/response problems/answers developed from metaphysical stimulations of the question-inquiry, interrogatory-examination and query-request.

FIG. 2 shows a Convention of Decision-Routine: A Procedure Method Schematic, for loua(MSR). According to an embodiment of the present invention, the loua(MSR) illustrates a system overview of procedural-component-modules used for transforming the three-planes of the trusted-terms of wisdom which make true-knowledge of the dimensional physical consciousness derived from the available input/output data meanings of truthful-information found and provided by the loua(MSR). FIG. 2 shows the procedural routine of the decisions which derive how the loua(MSR) processes the data given and received through the holographic network of neural-domains formed by the triangulation of the matrix words of DEW terms.

Referring to FIGS. 3A, 3B, and 3C, illustrate The Three Spectral Domains of Life, the triad perspective of a personality and a functionally dynamic-set of symbols that are used as data-code-models. FIG. 3A Fashions a Holographic Machine Method Explanation shows the Being vortices of Spirit, Mentality, and Energy as a Metaphysical Process Paradigm Drawing, of the loua(MSR). According to an embodiment of the present invention, the 300 illustrates The Metaphysical Paradigm Perspective, which is the Dialectic Model used by the loua(MSR) that infers and deduces the personality of the Body, Mind and Soul and its functionality in producing the dynamic-set of symbols that are used as data-codes.

FIG. 3A provides the Model of the selfless word discernment dialectic, which derives the advance consciousness of the conscience that uses the programming, which creates the procedural method of the Flow Routines. The Chart of FIG. 2 infers the potential wisdom of the proofing terms, which are determined by the Method of Mentality; where label 304 shows the line of points forming the vertical axis of Emotion common to the other axes. Labels 305, 306, and 307 shows the line of points that forms the axis of Desire (Thought), which manifest the mystic-conscience of the superego, as the soul source, which creates the holographic manifold of spirit. Label 306 shows the line of points that forms the axis of Desire (Word), which manifest conscious-metaphysical thought of the ego that creates the holographic manifold of mentality. Label 307 shows the line of points that forms the axis of Desire (Deed), which manifest subconscious-physical thought of the id, which creates the holographic manifold of energy. Label 304 of FIG. 3A shows the center-points of the positive and negative Emotion Vector of Emotion of the id, ego, and superego as the vertical line of Emotion points bisects each of the other domains. Emotion links the id, the ego, and the superego (see FIG. 4A Axion-Threads), which form the axis of the Personality-Matrix of all thoughts, words, and deeds. Labels 301, 302 and 303—point to the Will S, M, B line axes for the mystic, metaphysic, and the physical attributes of personality such as super-ego, ego, which creates the identity of Human Beings.

FIG. 3B shows the general model of the axis plane of the spirit generated by the vortex pixel-manifold of the universe of Being, produced by Vortex-Pixel-Manifold of FIG. 3C. FIG. 3C creates the holographic-pixels which manifest conscience, consciousness of the subconscious of life and its languages, where the Emotion Vector Point and its associated vectors construct the Desire and Will of the energy, mentality, and spirit that is applied by the loua(MSR) to resolve the problems in question. Again, FIG. 3A shows the collective vortex points of FIG. 3C. FIG. 3C shows the general model of the holograph-creation-manifold of energy, mentality, and spirit that produces the iterations of the Being-Universe-Spectrum of Plane sat 700 in FIG. 7B. FIG. 3 is the metaphysical rendition, which inclusively shows the general model of the intersection of DEW (The Holographic-Pixel Points of Illumination which Images Existence) as the Vortex-Pixel-Manifold Points which Source-Existence within the Universe of Being Spirit, Mentality, and Energy.

In an embodiment, FIG. 3A of 300 illustrates the domains of the DEW universe from a metaphysical perspective; where the personality attributes of each entity designs the self, and as such, the Mind System Replicator is able to decipher the personality coding to correct the chaos of the words that hide the truth.

Referring to FIG. 4A, illustrates the threads of the DEW fractal axis. The FIG. 4 400 shows the brake down of the DEW Axis Model for better conceptualization of the triform structure, which builds the Fractal Axis Model where the strands are the positive and negative current of the fiber which flows along the threads of existence which ignite the LIFE of the conscience, its consciousness, and its subconscious. FIG. 4A, Axon Motor Model, which is a Metaphysical concept drawing of the loua(MSR) terms transmitting Braid. The Axon-Loops and delooping habit forms the neural-network process, which programs and creates the routine lattice of behavioral-identity. According to the embodiment of the present invention, illustrates the braid of the vortices, which make the points of the holograms from the vortex-string that manifest the matter, which materializes the particles of mass causing the vibrating universe-fibers of the DEW fractal axis as shown in FIG. 3. Axon-Braids are made from the Thoughts, Words, and Deeds generated from the Identity-Awareness-Hologram-Machine, for it forms the matrix-axis of lines labeled as the 400, which create the vortex-manifold that, manifest each point on the lines that make the shapes and volumes for the planes of the universe of Being. All lines of conscience, conscious, and subconscious comprehension as in FIG. 3 are constructed by the Treads of Axon-Motor, which is labeled as FIG. 4B. FIG. 4B is the machine, which constructs the data used in standard databases, which prompt queries on the inter-net to discover the data-evidence from the search process for the data-interrogatory-input, which directs the query-results. Further, the Network-Domain-Search-Engines 103 compares the known-solution-facts and opinions, which address valid-probable-answers for the inquiry of the questions, to provide Positive Solutions. 401 shows, the plane generated as in FIG. 3B, by each of the DEW vortex-holograph created by the DEW vectors. 400—refers to the drawing that shows the S, M, B vortex module. The vectors of DEW create the Braid of the 401S, 402M, 403B filament threads of the Desire axes INPUT/OUTPUT; whereas 404SMB is the common Emotion axis INPUT/OUTPUT; where 405S, 406M, 407B are Will axes INPUT/OUTPUT fractal-filaments which form the vortex that coincides with the convention of 304, in FIG. 3A-3C.

Referring to FIG. 5A, illustrates the physical expression of the global existence of the Orbit model that serves to connect the dots of the Mind System Replicator as the paths of desire, emotion, and will (DEW) forms the planes of Being Identity Exploration while conscious thought investigates its behavior in terms of intent, purpose and motive. FIG. 5A, Orbit Pattern —The Metaphysical concept drawing of the Spatial relationships of the vortex fractals as in FIG. 5A propagate existence in accordance with the embodiment of the present invention as show in FIG. 5B. This pattern derives the physical expression that gives sense to the global of existence. The Orbit Pattern of FIG. 2 serves to connect the dots of the Mind System Replicator. 500 refers to the Center Point S, M, and B lines of the drawing that shows the S, M, and B vortex module. The vectors of DEW create the energy, mentality, and spirit (EMS) Braid of the 400 filaments form the threads of DEW, that form the Orbit model that serves to connect the dots of the Mind System Replicator. Center Point S, M, and B 500 refers to the Visualization of mind/soul relationship as a physical expression in terms of will, emotion, and desire as a ratio of energy, mentality, and spirit (EMS) behavioral-nature. 500 thru 509 shows the Globe of Existence Input/Output as an Orbit Model of the DEW Vortices which are manifested from the language vectors that form the words and terms of Being. 501S, 502M, 503B are the axes of Desire Input, 506, 508, and 509 are axes of declination-permutation (ascension within a latitude) relative to the plane above; as 505S, 506M, 507B are the axes of S, M, and B which manifest the Will of Humanity as Output of the loua(MSR).

The Orbit Pattern constitutes the axis of Emotion 504 SMB, the axis of the Will 505S, 506M, 507B, and the axis of Desire 501S, 502M, 503B, —all other lines are iterations, probabilities within the permutations of Being Identity. The Orbit Pattern in total is a look at the Machine in FIG. 3a; where the intersection of 504 SMB, 505S, 506M, 507B, and 501S, 502M, 503B is the OHM Vortex 500, which makes life's chakra that from the Point of the Singularity of the Duality of Individuality. The Globe of Existence forms the Permutations of Emotion, The Probabilities of Desire, and the Iterations of The Will creating the sphere of Being as depicted in FIG. 5A as in FIG. 4B, FIG. 3C, and FIG. 6B all being the same device as is this whole presentation is a look at Desire, Emotion, Will as the Creator.

Referring to FIGS. 5A and 5B. The drawings allows the visualization of the Mind/Soul relationship as a physical expression of the 11 CHAKRAS as Fractals of DEW: where at the center of the drawing is The OHM of Singularity, which is equal to the Essence of DEW; the axes of the drawing provide a visual image of the MIND/BODY/SPIRIT Relationship. The twelve axes represent the basic personality probabilities of existence. The Soul is the Attitude within the Syntax of the civil identity created by an ordered system, when the Mind is the Logic within the Rule created by the inclusive order, which forms the system; where the Selfless Body is the Entity, which forms from the inclusive order, and civil behavior created, evolved and perfected.

In an embodiment, the screen-shot 500 shows the global existence of the orbit model that serves to connect the dots of the Mind System Replicator. The loua(MSR), Mind System Replicator screen-shot allows visualization of the Mind/Soul Relationship as a physical expression of the CHAKRAS as fractals of Emotion (E) 504 SMB, Desire (D) 501S, 502M, 503B and (W) 505 505S, 506M, 507B (with respect to FIG. 5A, wherein the center of the drawing depicts a OHM, which is equal to the Essence of DEW. The axes of the screen-shot provide the visual of the MIND/BODY/SPIRIT Relationship. FIG. 5B shows the general model of the vortex manifold that constructs the Universe of Being as depicted in FIG. 5A. The twelve axes represent the basic personality probabilities of existence, wherein the Soul is the Attitude and Syntax of the civil identity created by an ordered system. The loua(MSR) forms the Word-Logic, which provides the Logos that Rule the creation of the identity-themes by the inclusive order of the topic to form the system and the Selfless embodiment of the Entity-subject from the inclusive order and civil behavior created, evolved, and perfected.

Referring to FIG. 6A-6B, illustrates, the Network of Domains as they are constructed of the Braid shown in FIG. 4. Vortex Machine 600 that Manifest which shows the Universe Milky Way of Desire, Emotion, and Will which Manifest Life and the Consciousness that provides the thoughts, words, and deeds of existence. 604 SMB depicts the Vector of Emotion for S, M, and B (Soul, Mind, Body) within Energy, Mentality and Spirit (EMS) of Being. 601S, 602M, and 603B depict the Axis of the Desire for S, M, and B (Soul, Mind, Body) within Energy, Mentality and Spirit (EMS) of Being. 605S, 606M, and 607B depict the Plane of the Will for S, M, and B (Soul, Mind, Body) within Energy, Mentality and Spirit (EMS) of Being. The forces of existence are sourced from within the one universe of Being; where the universe is constructed from the threads formed of DEW braids, creating the vortex-vacuum; where the vortex vacuum is continuum of mass, space, and time of the holograph, which manifest the points that manifest the Domain Consciousness and Sub Domain of the Subconscious, and the Singular Domain of Conscience which collectively fuel life as it is the manifestation of the Mystic DEW Way, which is not unlike the Milky Way Nature of the physical universe of energy. FIG. 6A depicts the Axes of DEW as a galaxy of DEW compounds vibrating within the waves the particles of DEW create. The waves produced by the Mystic DEW manifest the physical matter the metaphysical mind perceives. FIG. 600 is the model of lines forming the planes of existence within FIG. 500, which shows The Globe of Existence, The Orb of Life within the Sphere of Being. FIG. 6A is The Being-Universe-Model, a Metaphysical Concept Drawing which, show the Scope of Being, as a Braid of the Nature Creating Energy, Mentality, and Spirit. FIG. 6A shows the (DEW) of alpha thought migrating through its permutations, its probabilities, and its iterations of behavioral awareness seeking its perfect-identity, where (WED) Machine of the Energy, Mentality, and Spirit of the Holographer which makes omega thought will be the equilibrium, balance and harmony that will prevail. FIG. 6B of 600 shows the same vortex model of (DEW), as in FIGS. 3C, 4B, and 5B, which Sources-Existence from within the Being-Spirit-Identity of the (WED) personality, of the Soul-Source-Force of Existence.

Referring to FIG. 7, illustrates the working of the mind system replicator 100, which creates the Spectral Vortex Holograph Machine that manifest the Network-Engine. In an embodiment, 700 depicts the Holographic-Vortex-Machine where Desire::Emotion::Will ratios create the perpendicular planes of thought that make up every point in the universe; where the trinity of conscience, conscious, subconscious manifest the DEW fractals, which materialize freewill. The drawing depicts the Matter-Engine manifesting the matrix particle motor, which forms within the Vortex-Machine vibration of the Energy, Mentality, and Spirit of the Holographer. The Energy, Mentality, and Spirit of the Holographer is that which manifest the concept of FIG. 4 of 400 that manifest the concept of FIG. 3 of 300, that manifest the concept of FIG. 6 of 600, which manifest the concept of FIG. 5 of 500, manifesting the Globe of Existence. In an embodiment, the Network-Domain-Search-Engine 103 as is configured to receive triad-dimensional data input of (DEW) Energy, Mentality, and Spirit (EMS) (with respect to FIG. 7) through various source and means as depicted in the figure. The loua(MSR) input of DEW EMS is then processed at the (DEW) intersect (with respect to FIG. 7); and then the processed physical conscious inquiry output solution of DEW EMS is provided as a choice, a reason, and a decision that reflects or replicates the metaphysical compounds of purpose, intent, and motive for the thoughts of civility, selflessness, and inclusion or the inverse of evil, selfishness, and exclusion. FIGS. 7A and 7B, is the Identity of the Holographic-Manifold of Energy, Nature, and Spirit—This metaphysical concept model shows the parts of the triform which creates the vortex, which generates the essence of the sense and expression of life. According to an embodiment of the present loua(MSR) invention, the model illustrates the perfect-working-decision-procedure-vortex of the virtual-term-machine's conscious-network-engine, which materializes the loua(MSR). FIGS. 7A and 7B form the vortex-planes, which compile the thought, words, and deeds of existence, these are the same planes, which form the physical, metaphysical, and mystic domains of life's consciousness.

FIG. 8, Is an example of Physical Expression of the Metaphysical Application of the loua(MSR). This is simply one physical presentation of the metaphysical concept, which has been described throughout. FIG. 8 shows an application for the fractal code triangulation as a matrix coding which allows the formulation of expert responses to questions asked.

In an embodiment, the FIG. 8 shows a screen-shot illustrates collection of the mined and the farmed language that forms the data used to transform the information into an output-response. Data can be collected by various means from a variety of information-source-formats such as any text, a document, a form, a table, a report, a program or any routine scanned memo, a query, and the list goes on to include the spoken word. Further, the collected data can be stored in various formats and can be accessed through various information formats, which convey term identification. For example, the data can be stored in the form of records, a group of records, a history tracking record, or the like and the stored data can be accessed through fields of data, records of data, a data element activity descriptor, or the like. Further, the various-data that constitute the elements of the symbols, which are studied and termed to consider and process for the construction of the core data associations within the collected data taken from the queries provided by System 100 Machine. The System 100 Machine is used to resolve the activity of FIG. 8 that outlines the operation-theme based on the activity maps; based on the media theme coverage; based on the organizational commitment monitor; or it may be based on the department vision objective or based on any given criteria that the user desires, because the loua(MSR) is simple an aid for procedural-decision-awareness that delivers Fact Based Solutions derived from the evidence of Truths that Prove the Terms of Wisdom; therefore the process delivers truthful answers to each problem within the network-process which is constructed from a system of data-diagram chart-programs that compute the flow of the decision-routine.

In an embodiment, the screen-shot 500, depicts the metaphysical holograph replicator of the planes of creation, which is manifested by the DEW Vortex of OHM as it serves to connect the dots of the Mind System Replicator. The loua(MSR), Mind System Replicator screen-shot allows visualization of the Mind/Soul Relationship as a physical expression of the CHAKRAS as fractals of emotion (E) as 504 SMB, the triforms of desire (D) as 505S, 506M, 507B, and trifolds of will (W) as 501S, 502M, 503B (with respect to FIG. 5), wherein the center of the drawing depicts a OHM, which is equal to the Essence of DEW. The axes of the screen-shot provides the visual of the MIND/BODY/SPIRIT relationship as the intersection of 504 SMB, 505S, 506M, 507B, and 501S, 502M, 503B creates the OHM Vortex Point 500 of Singularity, Individuality, and Duality of the Orbit of Life for the Globe of Existence within the sphere of Being. The twelve axes represent the basic personality probabilities of existence, wherein the Soul is the Attitude and Syntax of the civil-identity created by an ordered system. The loua(MSR) forms the Word-Logic, which provides the Logos that Rule the creation of the identity-themes by the inclusive-order of the Symbol-Topic to form the system of the Selfless embodiment of the Entity-subject from the inclusive order by the civil behavior created, evolved, and perfected.

Referring to FIG. 6, illustrates the Mystic DEW Way (not unlike the Milky Way of the physical universe). FIG. 6 depicts the Axes of DEW as a galaxy of DEW compounds vibrating within the waves the particles of DEW create. The waves produced by the Mystic DEW manifest the physical matter the metaphysical mind perceives. FIG. 600 is the method of the pixels creating the planes of Being within FIG. 500.

In an embodiment, FIG. 700 depicts the Vortex-Machine where Desire::Emotion::Will ratios create the perpendicular planes of thought that make up every point in the universe where the trinity of conscience, conscious, subconscious manifest the DEW fractals which materialize the freewill of Being. The drawing depicts the Matter-Engine manifesting the matrix particle motor, which forms within the vibration of Vortex-Machine, which then forms FIG. 400 that forms the entity of FIG. 300 that forms the entity of 500 that forms the entity of 600's depiction.

In an embodiment, the Network-Domain-Search-Engine 103 is configured to receive triad-dimensional data input of 701 the symbols of emotion, 704 terms of the will, and 707 words of desire (with respect to FIG. 7) through various source and means as depicted in the figure. The loua(MSR) input 701 of emotion is then processed at the location 702 (with respect to FIG. 7); and then the processed physical conscious inquiry output forms the topic solution 703 provided. The physical conscious topic output forms the solution 703 (with respect to FIG. 7) as 706 is the resulting-decision and 709 is the reasoned response that reflects or replicates the metaphysical compounds of the intent purpose and motive for the thoughts of selflessness, and inclusion civility or the inverse evil which produces solutions of exclusion selfishness.

The foregoing description of the specific embodiments will so fully reveal the general nature of the embodiments. Herein others can, apply this current knowledge, and readily modify and/or adapt this knowledge for various applications so that such specific embodiments, without departing from the generic concept. This current embodiment can therefore, be adapted and modified within the intended comprehension of the meaning and range of equivalents in these disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A mind system replicator is comprised of:
An array of dedicated servers which are used to store the triad-dimensional-language of fractal-symbols as data codes formed of the words-logos, and categorical-terms which describe the people, places, and things of each inquiry allowing all thought, word, and deed to be named and numbered with distinct Wisdom-Identity-Surety-Trust-Terms. These Wisdom-Identity-Surety-Trust-Terms constitute the true-individual-aspects of knowledge-confidence which form the meaning-certainty of the data-code-truths whose collection is made through various means; as a plurality of Network-Domain-Search-Engines apply inductive and deductive reasoning to make inquiry, interrogatory and query, on any content, to determine the quality of triad-dimensional-purpose, motive and intent. The input data of the Truthing-Motor codes the words that are used to deduce the motives, which drives the intention-nature of the will's identity; as the identity is the expression of the emotions which form the desires of the entity's motives. This coding is stored, on the array of dedicated servers, as the data-code linked to the text of the information-source.
The plurality of the loua(MSR) Program Operations are supported with a set of library functions for driving the fractal-search-process which supplies the logic for implementing said inductive and deductive-reasoning, which makes the inquiry, interrogatory and query that qualifies the quantity and quality of the trueness, truthfulness, and trust which builds each solution inquiry provided, from the data-code of the Word-Logos within the Category of Terms communicated.

2. The system as claimed in claim 1, wherein said system is configured to receive said triad-dimensional-fractals that form the data-code, which identifies the intent of the theme of the query. The fractal-elements of language consist of individual-aspects of metaphysical-conscious-sense, the essence of the mystic conscience and the expression of the physical-subconscious, which make the products of each topic in question. The questions of the emotion are formed from the desired subject within the query of the will, which manifest the triad-dimensions that form the objective from which all other dimensional-domain-subsets are sequenced and manifested from the system-logic-motives of the selves of existence.

3. The system as claimed in claim 2, wherein the metaphysical senses of an individual determines the behavioral-mentality; where the purpose and/or point of the individual-aspects of choice-purpose is based on the motive and intent of the individual's inclusive or exclusive-sense which forms the entity's self-data coding of personality attitude and personal-attributes which create each category of correspondence terms.

4. The system as claimed in claim 3, codes and qualifies the integrity, morals and ethics of language by its trueness, truthfulness and trustfulness. The search question and answer of thoughts, words, and deeds are used to determine whether the quality of the symbols, logos, and categories of terms convey a positive or a negative essence, sense, and expression of the language. For language either conveys inclusive, selfless and civil intent, or it is a manifestation of exclusive-purpose, selfish-motive and evil-intent creating the un-trustful, untrue and false motives of an uncivil humanity.

5. The system as claimed in claim 2, wherein the mystic conscience of an individual determines the behavioral-spirit; to determine whether the ideas are emotions of positive inclusivity or negative exclusive-factors of the individual's entity identity. The factors are based on the desire and will that qualify the individual-aspects, which determines if the thoughts, words, and deeds are the motive of the entity's esteem-personality or the entity's egocentric-personality.

6. The system as claimed in claim 2, wherein the physical expression of an individual determines the behavioral-energy, such as character of an individual, which is based on attitude-temperament and behavioral-nature that manifest the individual-aspects of conscience, its consciousness, and its subconscious as the entity's personal motive.

7. The system as claimed in claim 1, wherein said system is configured with nested network of process engines that are designed to mine, grow and farm, the triad-dimensional input/output data code to improve the human condition and its resulting humanity based on The Processes of Life. For If, “The Inclusive-Power-Process manifest Each-Individual of Life-Including the Forces of All-Things of the Existence-System within the Modulation-Procedure of Every-Living-Creation of Being; where this is known as Singularity; then All=(Each Thing of Existence)/(Every Identity of Being) as Life=(Existence)(Living)=Singularity . . . ” 1) The Mystic-life process of Conscience-Singularity Power is the soul-entity existence-matrix-system-program of the superego's thought, word, and deed forces that occur within the Being experience modulation-routine-procedure; so then the Life of Conscience-Singularity is the source of the Self within the routine of the Being Creation Reality of Our Spirit. The soul is the mystic-processor that receives input and sends output between the body and mind. 2) The Metaphysical-life process of Consciousness-Individuality is the mind-entity system-program of the ego's thoughts, words, and deeds within the Being-experience routine-procedure; where Life is the Exploration of the Self within the routine of the Being Evolution Reality of Our Mentality; where the mind is the metaphysical-processor that receives input and sends output between the body and soul. 3) The Physical-life process of Subconscious-Duality is the body-entity program of the id's thoughts, words, and deeds system within the Being experience routine-procedure; where Life is the Habit of the Self within the routine of the Being Perfection Reality of Our Energy; where the brain is the physical-processor that receives input and sends output between the mind and soul.

8. The systems as claimed in claim 7, wherein said nested network of process engines and parallel-series of procedures are comprised of: An interrogatory-truthing-motor which drives an inquiry-truing-engine that is used as an information-growing tool used to mine and implement the trust inferred by the Internet triad-dimensional input data. There is a truthing-motor within an application-machine, that is used, as a data-growing-tool, which considers the expert-opinions, to determine the facts of quality, attribute, and nature of the request command. There is a solution-engine which uses the truthing-motor and application of the trust-machine as a fact-farming-device to grow-evidence to prove the quality of the solution output in terms of choice, reason, and decision, which uses the valid-logistics, strategy, and game-plan of the loua(MSR).

9. A method for transforming the triad-dimensional individuality-aspect to form the data, which makes the conscious solutions, wherein said method is comprised of:
a) Accepting, said certainty of the triad-dimensional-language which is derived as input data through various means;
b) Applying, an inductive and deductive-reasoning-logic for the inquiry, interrogatory and query on the triad-dimensional-individuality of the language-aspects, which form the data that is stored on the array of dedicated servers; and
c) Transforming said triad-dimensional-language into input data to search for conscious-physical solutions to produce output information that acts as a means for improving the human condition and its resulting humanity.

10. The method as claimed in claim 9, wherein said method reflects or replicates the metaphysical elements of purpose, as the motive within the intent which forms the thoughts of selfless-motive which manifest inclusive-purpose and civil-intent; where positive-order is the opposite consciousness of the negative-order of exclusive, selfish and evil behavioral nature.

11. The method as claimed in claim 9, wherein said method implements a nested network of process engines that are designed to grow, farm, and cultivate the triad-dimensional-language as input data which is used to derive output statements that might be used to improve the human condition and its resulting humanity.

12. The method as claimed in claim 9, wherein said nested network processes are as follows:
Truing-Engine, Truthing-Motor and Trust-Machine
i.) A Truthing Motor finds the prejudice of the truthed-variables studied, and then provides the consensus of expert-opinion on the facts of the Truing Engine Search relative to the negative and positive language-symbols acquired. The data then becomes part of the information-data-code-mining-system of the cyberspace-matrix where the triad-dimensional-language feeds the truthing-motor which fuels the trust-application-machine that is used as a data-growing tool which reasons expert ability in terms of witnessing proof by extracting the facts of the quality, attribute, and nature of the understanding-explored; and
ii.) The loua(MSR) solution-engine uses the truthing-motor and the trust-application-machine for processing the fact-farming of solutions which provides output choices, reasoning, and decision, with logistics, strategy, and game-plan.

13. The method as claimed in claim 9, wherein the method reveals the intent, purpose, and motive based on the opinion, fact, and/or fiction of each action/reaction of endeavor which forms each stimulus/response of the input data code, that produces the dimensional-fractal-law of the language symbols which in turn reveals the terms of civility or incivility.
